(19) United States
(12) Patent Application Publication
(10) Pub. No.: US 2025/0358782 A1
(43) Pub. Date: Nov. 20, 2025

(54) METHOD AND APPARATUS FOR DYNAMIC ADJUSTMENT OF A LOCATION REPORTING TRIGGER IN A WIRELESS COMMUNICATION SYSTEM

(71) Applicant: Samsung Electronics Co., Ltd., Gyeonggi-do (KR)

(72) Inventor: Sapan Pramodkumar SHAH, Bangalore (IN)

(21) Appl. No.: 19/210,328

(22) Filed: May 16, 2025

(30) Foreign Application Priority Data
May 20, 2024 (IN) 202441039357
Mar. 6, 2025 (IN) 202441039357

(51) Int. Cl. H04W 64/00

(52) U.S. Cl. CPC H04W 64/006

(57) ABSTRACT

The disclosure relates to a fifth generation (5G) or sixth generation (6G) communication system for supporting a higher data transmission rate. Disclosed is a method performed by a service enabler architecture layer (SEAL) location management (LM) server in a wireless communication system, the method comprising, receiving, from a vertical application layer (VAL) server, a first message for triggering a location reporting, the first message including an identity of a user equipment (UE) and an indicator for requesting a suggestion for an adaptive location reporting configuration, identifying the adaptive location reporting configuration based on a dynamic adjustment of a location reporting configuration by analysing location information of a client for the UE, and transmitting, to the VAL server, a second message for suggesting the adaptive location reporting configuration.

### CROSS-REFERENCE TO RELATED APPLICATION(S)

This application is based on and claims priority to Indian Provisional Patent Application 20/244,1039357, which was filed in the Indian Intellectual Property Office on May 20, 2024, and to Indian Complete patent application No. 202441039357, which was filed in the Indian Intellectual Property Office on Mar. 6, 2025, the contents of each of which are incorporated herein by reference in their entireties.

### BACKGROUND

### 1. Field

The disclosure relates generally to wireless communication systems, and more particularly, to methods and systems of dynamic adjustment of a location reporting trigger in a wireless communication system.

### 2. Description of Related Art

Fifth generation (5G) mobile communication technologies define broad frequency bands such that high transmission rates and new services are possible, and can be implemented in sub 6 gigahertz (GHz) bands such as 3.5 GHz, and in above 6 GHz bands referred to as millimeter wave (mmWave) bands including 28 GHz and 39 GHz bands. In addition, it has been considered to implement sixth generation (6G) mobile communication technologies referred to as beyond 5G systems in terahertz (THz) bands (e.g., 95 GHz to 3 THz bands) to accomplish transmission rates fifty times faster than 5G mobile communication technologies and ultra-low latencies one-tenth of 5G mobile communication technologies.

Since the beginning of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

There are also ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there is ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for NR for simplifying random access procedures. There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The 3rd generation partnership project (3GPP) has established a set of standards to enhance mobile communication systems, which include service enabler architecture layer (SEAL) services as defined in the relevant standard. SEAL services encompass various functionalities, among which the location management (LM) service plays a critical role. The SEAL LM service supports features such as event-based location reporting, on-demand location reporting, location information subscription, obtaining UE information from specific areas, monitoring location deviations, and location area monitoring.

The vertical application layer (VAL) server leverages SEAL LM services to collect location reports from its subscriber UEs, thereby enhancing service efficiency. The process involves the VAL server providing location reporting configurations to the SEAL LM server, which subsequently configures triggers on the SEAL LM client in the UE. Based on these triggers, the UE generates and shares location reports with the SEAL LM server, where the reports may include parameters such as the required positioning method, required accuracy, type of location, and frequency of location reports.

Despite the structured approach, the conventional system exhibits several deficiencies. One significant issue is the lack of consideration for the specific conditions and capabilities of the UE when configuring location report triggers. For instance, the UE may support a positioning method different from the one specified in the configuration. This discrepancy can lead to suboptimal performance and inaccurate location data.

Moreover, the static nature of the location reporting configuration can result in inefficient resource utilization. If the UE remains mostly static, frequent location report requests are redundant and unnecessarily consume resources. If the UE is highly mobile but the reporting frequency is too low, the VAL server may not receive timely and accurate location information. This lag in data affects the quality of service provided to the UE, potentially leading to degraded user experience and service inefficiencies.

Specifically, in the conventional art, a VAL server or a SEAL LM server may provide the location reporting configurations to the UE without considering factors such as the UE's positioning method, mobility, and frequency of location reports. As a result, the UE may send inaccurate or irrelevant location reports to the SEAL LM server, which negatively impacts the quality of service provided to the UE.

As such, there is a need in the art for a method and apparatus to dynamically adjust the location reporting trigger within the communication system.

### SUMMARY

The disclosure has been made to address at least the above-mentioned problems and/or disadvantages and to provide at least the advantages described below.

Accordingly, an aspect of the disclosure is to provide a method and apparatus which address problems that arise when configuring the location reporting triggers for the UE without considering the UE's conditions.

An aspect of the disclosure is to provide for a method and apparatus for dynamically updating and adjusting location reporting triggers based on the UE's conditions is evident, to ensure that location reporting is both efficient and accurate, tailored to the real-time status and capabilities of the UE.

An aspect of the disclosure is to provide a method and apparatus for sending accurate and relevant location reports to the SEAL LM server to improve the quality of service provided to the UE and enhance the overall efficiency and reliability of the communication network.

An aspect of the disclosure is to provide a method and apparatus that are applicable to various communication networks and services that utilize location reporting, such as fleet management, mobile advertising, and emergency response systems.

In accordance with an aspect of the disclosure, a method performed by a service enabler architecture layer (SEAL) location management (LM) server in a wireless communication system includes receiving, from a vertical application layer (VAL) server, a first message for triggering a location reporting, the first message including an identity of a user equipment (UE) and an indicator for requesting a suggestion for an adaptive location reporting configuration, identifying the adaptive location reporting configuration based on a dynamic adjustment of a location reporting configuration by analysing location information of a client for the UE, and transmitting, to the VAL server, a second message for suggesting the adaptive location reporting configuration.

In accordance with an aspect of the disclosure, a method performed by a vertical application layer (VAL) server in a wireless communication system includes transmitting, to a service enabler architecture layer (SEAL) location management (LM) server, a first message for triggering a location reporting, the first message including an identity of a user equipment (UE) and an indicator for requesting a suggestion for an adaptive location reporting configuration, and receiving, from the SEAL LM server, a second message for suggesting the adaptive location reporting configuration based on a dynamic adjustment of a location reporting configuration by an analysis on location information of a client for the UE.

In accordance with an aspect of the disclosure, a service enabler architecture layer (SEAL) location management (LM) server in a wireless communication system includes a transceiver, and a controller coupled with the transceiver and configured to, receive, from a vertical application layer (VAL) server, a first message for triggering a location reporting, the first message including an identity of a user equipment (UE) and an indicator for requesting a suggestion for an adaptive location reporting configuration, identify the adaptive location reporting configuration based on a dynamic adjustment of a location reporting configuration by analysing location information of a client for the UE, and transmit, to the VAL server, a second message for suggesting the adaptive location reporting configuration.

In accordance with an aspect of the disclosure, a vertical application layer (VAL) server in a wireless communication system includes a transceiver; and a controller coupled with the transceiver and configured to: transmit, to a service enabler architecture layer (SEAL) location management (LM) server, a first message for triggering a location reporting, the first message including an identity of a user equipment (UE) and an indicator for requesting a suggestion for an adaptive location reporting configuration, and receive, from the SEAL LM server, a second message for suggesting the adaptive location reporting configuration based on a dynamic adjustment of a location reporting configuration by an analysis on location information of a client for the UE.

In accordance with an aspect of the disclosure, a method for adjusting a location reporting trigger including receiving, by an enabler server, a request message from an application server, the request message comprising an identity of a target user equipment (UE), receiving, by the enabler server, an indication that the application server is required to a suggestion for an adaptive location configuration from the enabler server, sending, by the enabler server, a response message to the request message received from the application server, the response message indicating an acceptance of the request message by the enabler server, determining, by the enabler server, the adaptive location configuration for the target UE by adjusting a location reporting trigger configuration based on a plurality of parameters associated with the target UE and the identity of the target UE, and sending, by the enabler server, a notification message to the application server, the notification message comprising the identity of the target UE and the adaptive location configuration comprising the adjusted location reporting trigger configuration as the suggestion.

In accordance with an aspect of the disclosure, a method for dynamically adjusting a location reporting trigger in a communication system includes sending, by an application server, a request message to an enabler server to receive an adaptive location configuration, the request message comprising an identity of a target UE for which the application server requires the adaptive location configuration and an indication for a suggestive update to indicate that the application server requires to receive a suggestion to the adaptive location configuration from the enabler server, receiving, by the application server, a response message from the enabler server indicating an acceptance of the request message by the enabler server, receiving, by the application server, a notification message from the enabler server, the notification message comprising the identity of the target UE and an adaptive location configuration comprising the adjusted location reporting trigger configuration for the target UE as the suggestion, determining, by the application server, whether the adaptive location configuration received from the enabler server is accepted or rejected by the application server, and sending, by the application server, an acknowledgement message in response to the notification message received from the enabler server, the acknowledgement message comprising whether the application server accepts or rejects the adaptive location configuration as the suggestion.

In accordance with an aspect of the disclosure, an enabler server for dynamically adjusting a location reporting trigger in a communication system includes a memory storing information about an application server and a plurality of user equipments (UEs) in the communication system, a processor; and an adaptive location configuration controller, coupled to the memory and the processor, wherein the adaptive location configuration controller is configured to receive a request message from the application server, the request message comprising an identity of a target UE for which the application server requires the adaptive location configuration and an indication for a suggestive update to indicate that the application server is required to receive a suggestion to the adaptive location configurations from the enabler server, send a response message to the request message received from the application server, the response message indicating an acceptance of the request message by the enabler server, determine the adaptive location configuration for the target UE by adjusting a location reporting trigger configuration based on a plurality of parameters associated with the target UE and the identity of the target UE, and send a notification message to the application server, the notification message comprising the identity of the target UE and the adaptive location configuration comprising the adjusted location reporting trigger configuration as the suggestion.

In accordance with an aspect of the disclosure, an application server for dynamically adjusting a location reporting trigger in a communication system includes a memory storing information about an enabler server and a plurality of user equipments (UEs) in the communication system, a processor, and an adaptive location configuration controller, coupled to the memory and the processor, wherein the adaptive location configuration controller is configured to send a request message to the enabler server to receive an adaptive location configuration, the request message comprising an identity of a target UE for which the application server requires adaptive location configuration and an indication for a suggestive update to indicate that the application server requires to receive a suggestion to the adaptive location configurations from the enabler server, receive a response message from the enabler server indicating an acceptance of the request message by the enabler server, receive a notification message from the enabler server, the notification message comprising the identity of the target UE and an adaptive location configuration comprising the adjusted location reporting trigger configuration for the target UE as the suggestion, determine whether the adaptive location configuration received from the enabler server is accepted or rejected by the application server, and send an acknowledgement message in response to the notification message received from the enabler server, the acknowledgement message comprising whether the application server accepts or rejects the adaptive location configuration as the suggestion.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an enabler server for dynamically adjusting a location reporting trigger in a communication system according to an embodiment;

FIG. 2 illustrates an application server for dynamically adjusting a location reporting trigger in a communication system according to an embodiment;

FIG. 3 illustrates a method for dynamically adjusting the location reporting trigger by the enabler server in the communication system according to an embodiment;

FIG. 4 illustrates a method for dynamically adjusting a location reporting trigger by the application server for in a communication system according to an embodiment;

FIG. 5 illustrates a method for location reporting trigger adjustment suggestion to an application server according to an embodiment;

FIG. 6 illustrates a block diagram of a UE according to an embodiment; and

FIG. 7 illustrates various hardware components of a network entity, according to an embodiment.

### DETAILED DESCRIPTION

The following description with reference to the accompanying drawings is provided to assist in a comprehensive understanding of the disclosure. It includes various specific details to assist in that understanding but these are to be regarded as merely examples. Accordingly, those of ordinary skill in the art will recognize that various changes and modifications of the various embodiments described herein can be made without departing from the scope and spirit of the disclosure. Descriptions of well-known functions and constructions may be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Examples of a UE include, but are not limited to, consumer electronics such as mobile phones and smartphones, tablets, wearable devices, televisions (TVs), computing devices such as laptops, notebooks, desktops, and workstations, IoT devices, automotive systems such as connected cars, autonomous vehicles, an V2X communication devices, enterprise devices such as robotics, specialized equipment such as medical devices and public safety devices, and media devices such as gaming and streaming devices.

Examples of the wireless communication network system herein include, but are not limited to, cellular networks such as 2^{nd} generation (2G), 3^{rd} generation (3G), 4^{th} generation (4G), 5G, and beyond 5G (B5G)/6G, or advanced cellular networks, local area networks (LANs) (such as Wi-Fi, Li-Fi, etc.), personal area networks (PANs) such as Bluetooth™ Zigbee™, or Z-Wave, wide area networks (WANs) such as satellite communication networks, long range WAN, narrowband IoT, and low-bandwidth communication for IoT, metropolitan area networks (MANs), machine-to-machine (M2M), Ad hoc and mesh networks, and emerging and advanced networks.

Herein, an enabler client may be a SEAL LM client, edge enabler client, or an application data analytics enablement (ADAE) client.

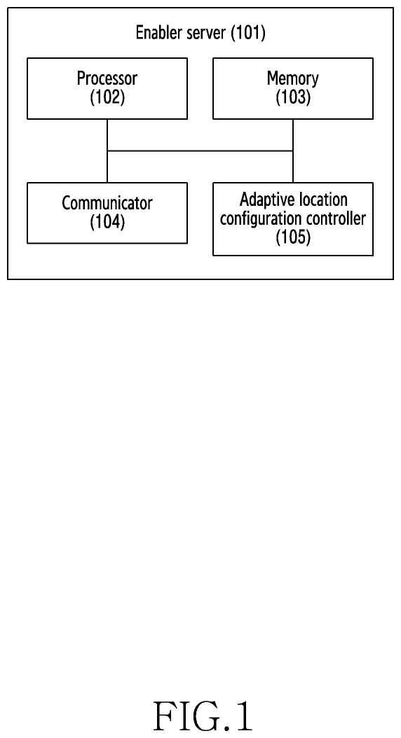

FIG. 1 is a block diagram of the enabler server (101) for dynamic adjusting the location reporting trigger in the communication system according to an embodiment.

Referring to FIG. 1, the enabler server (101) is also referred to as the SEAL LM server. The SEAL LM server refers to the server that manages location information within the context of the SEAL for verticals standard, precisely handling LM functions usually within the telecommunication industry, particularly for 5G networks.

The SEAL for verticals standard provides a framework for various industries, such as automotive, healthcare, and manufacturing, by leveraging 5G networks. The SEAL LM ensures efficient LM, including acquiring, processing, and distributing precise geolocation data to network entities and applications. Accurate location information is crucial in 5G networks for applications like autonomous driving, remote surgery, and smart manufacturing. The SEAL LM server manages this data to meet the stringent requirements of these applications, integrating with other network components to provide seamless location services and fully utilize 5G's high-speed, low-latency, and high-reliability features. The SEAL LM server is scalable and flexible, supporting various location technologies such as GPS, Wi-Fi positioning, and cellular network-based methods. This versatility makes it essential for deploying 5G networks across different industries, allowing each vertical to maximize the benefits of 5G technology.

The enabler server (101) includes the processor (102), the memory (103), a communicator (104) and the adaptive location configuration controller (105). For example, the enabler server (101) can include, but is not limited to a base station access point, a central server, or similar equipment. The processor (102) of the enabler server (101) communicates with the memory (103), the communicator (104) and the adaptive location configuration controller (105). The processor (102) executes instructions stored in the memory (103) and to perform various processes. The processor (102) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an AI dedicated processor such as a neural processing unit (NPU).

The memory (103) of the enabler server (101) includes storage locations to be addressable through the processor (102). The memory (103) includes information about the application server (201) and a plurality of UEs in the communication system. The memory (103) is not limited to a volatile memory and/or a non-volatile memory. The memory (103) can include one or more computer-readable storage media. The memory (103) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories.

The communicator (104) is configured for communicating internally between internal hardware components and with external devices (client device) via one or more networks. The communicator (104) includes an electronic circuit that enables wired or wireless communication. The adaptive location configuration controller (105) is coupled to the memory (103) and the processor (102) to allow for efficient data transfer and communication between the components, ensuring that the adaptive location configuration controller (105) can access and process location data in real-time.

The adaptive location configuration controller (105) is an innovative integrated circuit that is implemented in the enabler server (101). The structure of such innovative integrated circuit includes a multi-core architecture that enables dynamic adjustment of a location reporting trigger in a communication system. Each core is optimized for specific tasks, such as signal processing, adaptive location configuration, and adjusting a location reporting trigger configuration, etc., integrated circuit for dynamic adjustment of a location reporting trigger in a communication system integrated circuit is made of a combination of analog and digital components designed to optimize the power consumption and performance of the location reporting mechanism. The analog components include a low-noise amplifier and a high-precision analog-to-digital converter to ensure accurate signal processing. The digital components consist of a microcontroller unit (MCU) and a digital signal processor (DSP) that work in tandem to dynamically adjust the location reporting trigger based on adaptive location configuration.

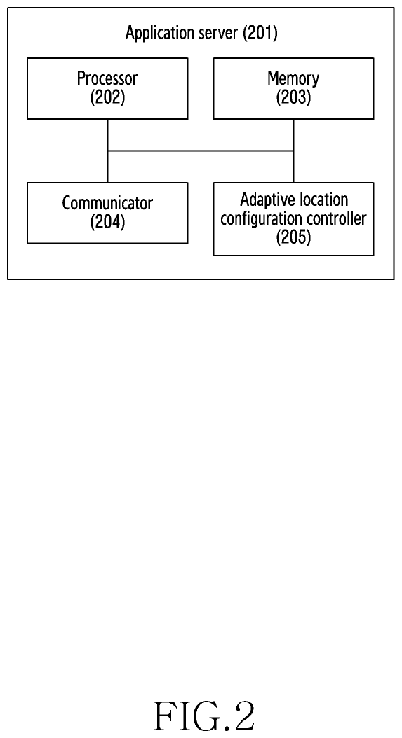

The adaptive location configuration controller (105) receives a request message from the application server (201 in FIG. 2) to receive the adaptive location configuration. The request message includes the identity of the target UE for which the application server (201) requires the adaptive location configuration and the indication for suggestive update to indicate that the application server (201) is required to receive suggestions for the adaptive location configurations from the enabler server (101). The adaptive location configuration controller (105) sends the response message to the request message received from the application server (201). The response message indicates the acceptance of the request message by the enabler server (101).

Upon receiving the request message, the adaptive location configuration controller (105) initiates a process to determine the most suitable adaptive location configuration for the target UE. This involves analyzing a plurality of parameters associated with the target UE, such as its mobility pattern, the capabilities it supports, the required location accuracy level, and the frequency at which it sends location reports. By evaluating these parameters, the controller can adjust the location reporting trigger configuration to optimize the performance and accuracy of the location services provided to the target UE. This process ensures that the location configuration is tailored to the specific needs and conditions of the target UE, thereby enhancing the overall efficiency and effectiveness of the location-based services.

Once the adaptive location configuration has been determined, the adaptive location configuration controller (105) sends a notification message to the application server (201). This notification message includes the identity of the target UE and the details of the adaptive location configuration, including the adjusted location reporting trigger configuration as a suggestion. The application server (201) then reviews the suggested configuration and sends an acknowledgement message back to the adaptive location configuration controller (105). This acknowledgement message indicates whether the application server (201) accepts or rejects the suggested adaptive location configuration. This feedback loop ensures that the application server (201) is the last entity in executing the configuration process, enabling the application server (201 to make any necessary adjustments based on its specific requirements or constraints.

In addition to determining the adaptive location configuration, the adaptive location configuration controller (105) is also responsible for storing and maintaining the plurality of parameters related to the target UE. This includes continuously monitoring and updating information such as the mobility pattern of the target UE, the capabilities the target UE supports, the required location accuracy level, and the frequency of location reports. By keeping this information current, the controller can make more informed decisions when adjusting the location reporting trigger configuration. This dynamic approach allows the controller to adapt to any changes in the target UE's conditions or requirements, ensuring that the location configuration remains optimal over time.

The adaptive location configuration controller (105) in the enabler server (101) plays a crucial role in determining whether to increase or decrease the frequency of location reports from the target UE. This decision is based on the plurality of parameters associated with the target UE, ensuring that the reporting frequency is aligned with the current needs and conditions of the UE. The controller also determines whether to adjust the location change condition and whether to change the positioning method supported by the target UE. By making these adjustments, the controller can optimize the location reporting trigger configuration, balancing the need for accurate and timely location information with the constraints of the target UE's capabilities and resources. This comprehensive approach ensures that the adaptive location configuration is both effective and efficient, providing the best possible service to the target UE.

The adaptive location configuration controller (105) initiates the on-demand location reporting procedure or the event-triggered location reporting procedure for the target UE when the application server (201) accepts the adaptive location configuration received from the enabler server (101). This initiation process involves configuring the target UE to report its location based on the triggers defined in the adaptive location configuration. The on-demand location reporting procedure allows the application server (201) to request the location of the target UE at specific intervals or under certain conditions, while the event-triggered location reporting procedure enables the target UE to automatically report its location when predefined events occur. These procedures ensure that the application server (201) receives timely and accurate location information, which is critical for applications that rely on precise location data.

FIG. 2 illustrates the application server (201) for dynamic adjusting the location reporting trigger in the communication system, according to an embodiment.

Referring to FIG. 2, the application server (201) may also be referred to as the VAL server. The VAL server serves specific vertical industry applications and interfaces with the SEAL server to utilize standardized services. The VAL server is designed to handle high-volume transactions and can be customized to meet the unique requirements of different industries, such as healthcare, finance, and manufacturing.

The application server (201) includes the processor (202), the memory (203), the communicator (204), and the adaptive location configuration controller (205). The processor (202) of the application server (201) communicates with the memory (203), the communicator (204) and the adaptive location configuration controller (205). The processor (202) executes instructions stored in the memory (203) and performs various processes. The processor (202) can include one or a plurality of processors, can be a general-purpose processor, such as a CPU, an AP, or the like, a graphics-only processing unit such as a GPU, a VPU, and/or an AI dedicated processor such as an NPU.

The memory (203) of the application server (201) includes storage locations to be addressable through the processor (202). The memory (203) includes the information about the application server (201) and a plurality of UEs in the communication system. The memory (203) is not limited to a volatile memory and/or a non-volatile memory. The memory (203) can include one or more computer-readable storage media and non-volatile storage elements such as magnetic hard discs, optical discs, floppy discs, flash memories, or forms of EPROM or EEPROM memories. The communicator (204) is configured for communicating internally between internal hardware components and with external devices (client device) via one or more networks. The communicator (204) includes an electronic circuit that enables wired or wireless communication.

The adaptive location configuration controller (205) is coupled to the memory (203) and the processor (202). The adaptive location configuration controller (205) is coupled to the memory (203) and the processor (202). This coupling allows for efficient data transfer and communication between the components, ensuring that the adaptive location configuration controller (205) can access and process location data in real-time. The adaptive location configuration controller (205) is an innovative integrated circuit that is implemented in the application server (201). The structure of such innovative integrated circuit includes a multi-core architecture that enables dynamic adjustment of a location reporting trigger in the communication system. Each core is optimized for specific tasks, such as signal processing, receive and transmit request and response messages, adaptive location configuration, and adjusting a location reporting trigger configuration, etc., integrated circuit for dynamic adjustment of a location reporting trigger in a communication system integrated circuit is made of a combination of analog and digital components designed to optimize the power consumption and performance of the location reporting mechanism. The analog components include a low-noise amplifier and a high-precision analog-to-digital converter to ensure accurate signal processing. The digital components consist of an MCU and a DSP that work in tandem to dynamically adjust the location reporting trigger based on adaptive location configuration.

The adaptive location configuration controller (205) sends the request message to the enabler server (101) to receive the adaptive location configuration. The request message includes the identity of the target UE for which the application server (201) requires the adaptive location configuration and the indication for suggestive update to indicate that the application server (201) requires to receive the suggested configurations from the enabler server (101). The adaptive location configuration controller (205) receives the response message from the enabler server (101). The response message indicates an acceptance of the request message by the enabler server (101). The adaptive location configuration controller (205) receives the notification message from the enabler server (101). The notification message includes the identity of the target UE and the adaptive location configuration. The adaptive location configuration includes the adjusted location reporting trigger configuration for the target UE as the suggestion. The adaptive location configuration controller (205) determines whether the adaptive location configuration received from the enabler server (101) is accepted or rejected by the application server (201). The adaptive location configuration controller (205) sends the acknowledgement message in response to the notification message received from the enabler server. The acknowledgement message includes whether the application server (201) accepts or rejects the adaptive location configuration suggestion.

Upon receiving the notification message, the adaptive location configuration controller (205) performs a thorough analysis of the suggested adaptive location configuration. This analysis may involve evaluating the current network conditions, the specific requirements of the application server (201), and the operational parameters of the target UE. The adaptive location configuration controller (205) ensures that the suggested configuration aligns with the operational goals and performance metrics set by the application server (201). If the suggested configuration meets these criteria, the adaptive location configuration controller (205) proceeds to communicate its acceptance to the enabler server (101).

Moreover, the application server (201) continuously monitors the performance of the location reporting procedures to ensure that they operate efficiently and effectively. If any discrepancies or issues are detected, the application server (201) can request further adjustments to the adaptive location configuration from the enabler server (101). This dynamic and adaptive approach allows the system to maintain optimal performance and reliability, adapting to changes in network conditions, user behavior, and application requirements. By leveraging the adaptive location configuration, the application server (201) can enhance the user experience, improve service quality, and achieve better resource utilization.

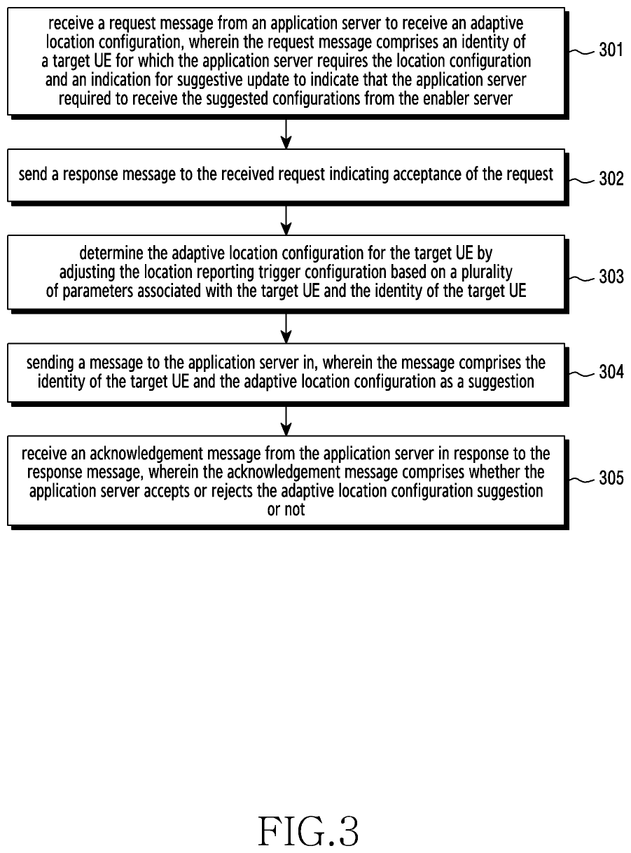

FIG. 3 illustrates a method for dynamically adjusting the location reporting trigger by the enabler server in the communication system according to an embodiment.

Referring to FIG. 3, at step 301, the method includes receiving by the enabler server the request message from the application server to receive the adaptive location configuration. The request message includes the identity of the target UE for which the application server requires the adaptive location configuration. The request message also includes the indication for a suggestive update to indicate that the application server is required to receive suggestions for the adaptive location configurations from the enabler server.

At step 302, the method includes sending by the enabler server the response message to the request message received from the application server. The response message indicates the acceptance of the request message by the enabler server.

At step 303, the method includes determining by the enabler server the adaptive location configuration for the target UE by adjusting the location reporting trigger configuration based on the plurality of parameters associated with the target UE and the identity of the target UE.

At step 304, the method includes sending by the enabler server the notification message to the application server. The notification message includes the identity of the target UE and the adaptive location configuration. The adaptive location configuration includes the adjusted location reporting trigger configuration as the suggestion.

At step 305, the method includes receiving by the enabler server the acknowledgment message from the application server in response to the notification message. The acknowledgment message includes whether the application server accepts or rejects the adaptive location configuration suggestion.

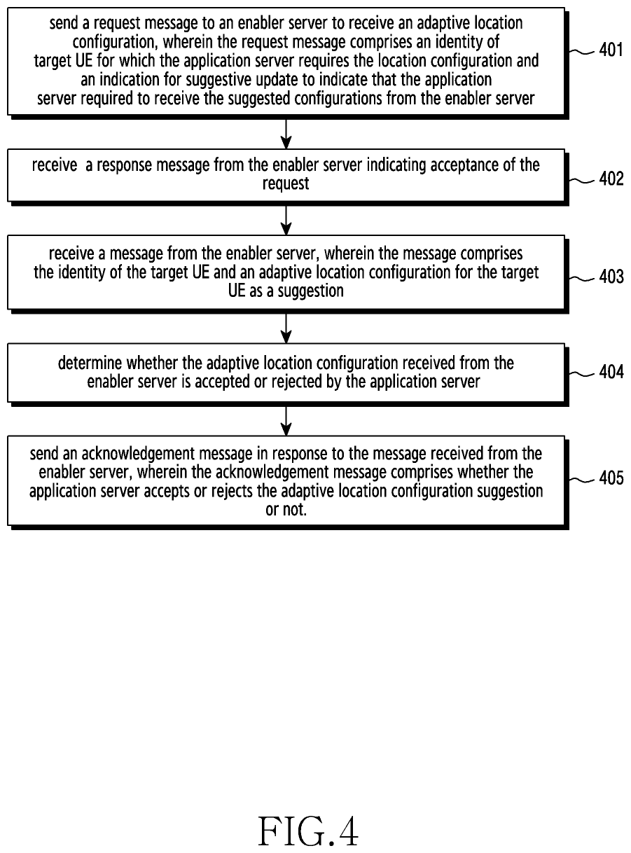

FIG. 4 illustrates a method for dynamically adjusting a location reporting trigger by the application server in the communication system according to an embodiment.

Referring to FIG. 4, at step 401, the method includes sending the request message to the enabler server. The request message includes the identity of the target UE for which the application server requires the adaptive location configuration. The request message further includes the indication for a suggestive update to indicate that the application server requires to receive the suggestions for the adaptive location configurations from the enabler server.

At step 402, the method includes receiving the response message from the enabler server. The response message indicates the acceptance of the request message by the enabler server.

At step 403, the method includes receiving the notification message from the enabler server. The notification message includes the identity of the target UE and the adaptive location configuration. The adaptive location configuration includes the adjusted location reporting trigger configuration for the target UE as the suggestion.

At step 404, the method includes determining whether the adaptive location configuration received from the enabler server is accepted or rejected by the application server.

At step 405, the method includes sending the acknowledgment message in response to the notification message received from the enabler server. The acknowledgment message includes whether the application server accepts or rejects the adaptive location configuration suggestion.

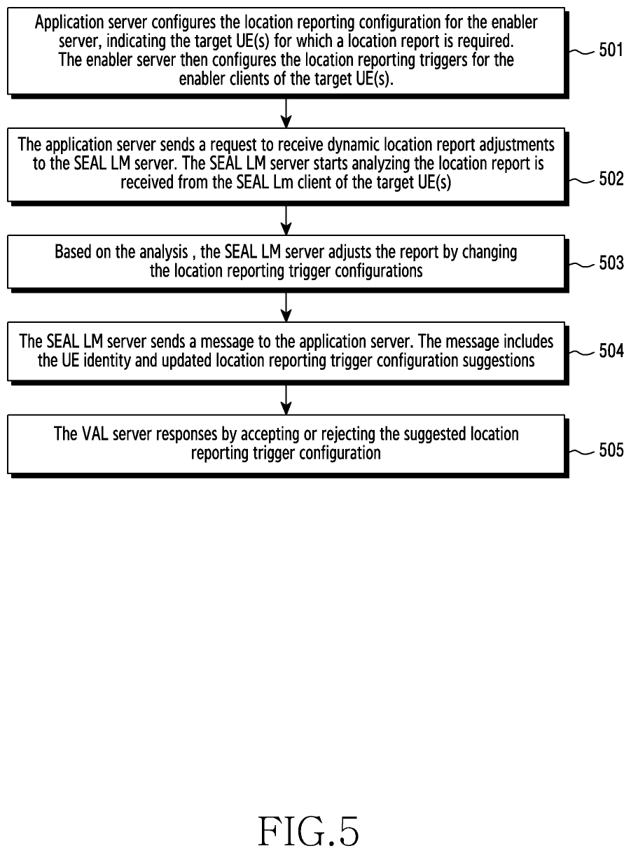

FIG. 5 illustrates a method for location reporting trigger adjustment suggestion to the application server according to an embodiment.

Referring to FIG. 5, at step 501, the method includes configuring the location reporting configuration by the application server for the enabler server indicating the target UE(s) for which the adaptive location report is required. The enabler server then configures the location reporting triggers for the enabler clients of the target UE(s).

At step 502, the method includes sending the request message by the application server to the enabler server to receive the dynamic or adaptive location report configuration. The request message includes the target UE identities for which the application server requires to receive the adaptive location report configuration and the indication for suggestive update. The enabler server starts analyzing the location reports received from the enabler client of the target UE(s) as informed by the application server. The request to receive suggestions for adjusting the dynamic or adaptive location reports can be included in the location reporting trigger request. In another embodiment, the request may be a subscription request for a new subscription event such as dynamic location reporting adjustment or any other suitable event name.

At step 503, the method includes determining, by the enabler server, the adaptive location configuration for the target UE based on the analysis. The determination includes adjusting the location reporting trigger configurations such as increasing or decreasing the report frequency based on the UE's mobility pattern, adjusting the location accuracy, or changing the required positioning method as supported by the UE.

At step 504, the method includes sending the notification message to the application server from the enabler server. The notification message includes the UE identity and the updated adaptive location configuration. The updated adaptive location configuration includes the adjusted location reporting trigger configuration suggestions. The message sent from the enabler server to the application server is the notification message.

At step 505, the method includes receiving the request from the enabler server by the application server and sending by the application server the acknowledgment message by acknowledging the response message to the enabler server. The acknowledgment message includes whether the application server accepts or rejects the updated adaptive location reporting configuration as the suggestion. If the application server accepts the adaptive location reporting configuration as suggested by the enabler server, then the enabler server updates the location reporting configuration to the enabler client of the target UE.

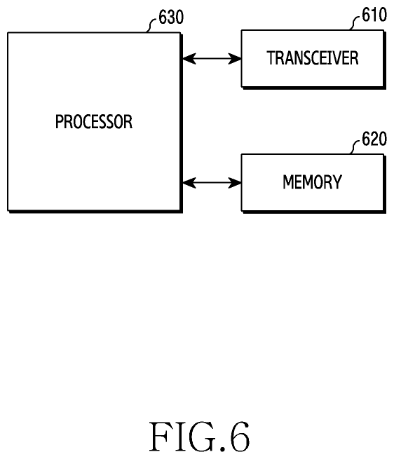

FIG. 6 illustrates a block diagram of a UE according to an embodiment.

Referring to FIG. 6, the UE may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. The processor 630, the transceiver 610, and the memory 620 may be implemented as a single chip. The processor 630 may include at least one processor.

The transceiver 610 collectively refers to a UE receiver and a UE transmitter and may transmit/receive a signal to/from a base station or a network entity. The signal transmitted or received to or from the base station or a network entity may include control information and data. The transceiver 610 may include an RF transmitter for up-converting and amplifying a frequency of a transmitted signal, and an RF receiver for amplifying low-noise and down-converting a frequency of a received signal. However, this is only an example of the transceiver 610 and components of the transceiver 610 are not limited to the RF transmitter and the RF receiver.

The transceiver 610 may receive and output, to the processor 630, a signal through a wireless channel, and transmit a signal output from the processor 630 through the wireless channel.

The memory 620 may store a program and data required for operations of the UE. The memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

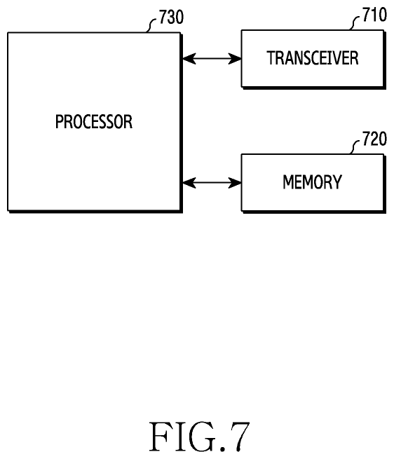

FIG. 7 illustrates various hardware components of a network entity, according to an embodiment. The network entity of FIG. 7 corresponds to the enabler server of FIG. 1 or the application server of FIG. 2.

Referring to FIG. 7, the network entity includes a transceiver 710, a memory 720, and a processor 730. The transceiver 710, the memory 720, and the processor 730 of the network entity may operate according to a communication method of the network entity described above. However, the components of the terminal are not limited thereto. For example, the network entity may include fewer or a greater number of components than those described above. However, the components of the network entity are not limited thereto. For example, the network entity may include more or fewer components than those described above. The processor 730, the transceiver 710, and the memory 720 may be implemented as a single chip. The processor 730 may include at least one processor.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver 710 collectively refers to a network entity receiver and a network entity transmitter and may transmit/receive a signal to/from a base station or a UE. The signal transmitted or received to or from the base station or the UE may include control information and data. In this regard, the transceiver 710 may include an RF transmitter for up-converting and amplifying a frequency of a transmitted signal, and an RF receiver for amplifying low-noise and down-converting a frequency of a received signal. However, this is only an example of the transceiver 710 and components of the transceiver 710 are not limited to the RF transmitter and the RF receiver.

The transceiver 710 may receive and output, to the processor 730, a signal through a wireless channel, and transmit a signal output from the processor 730 through the wireless channel.

The memory 720 may store a program and data required for operations of the network entity. The memory 720 may store control information or data included in a signal obtained by the network entity. The memory 720 may be a storage medium, such as a ROM, a RAM, a hard disk, a CD-ROM, and a DVD, or a combination of storage media.

The processor 730 may control a series of processes such that the network entity operates as described above. For example, the transceiver 710 may receive a data signal including a control signal, and the processor 730 may determine a result of receiving the data signal.

As described above, provided herein is a method for dynamically adjusting the location reporting trigger in the communication system. The method includes receiving by the enabler server a request message from the application server to receive an adaptive location configuration. The request message includes an identity of a target UE for which the application server requires the adaptive location configuration and an indication for a suggestive update to indicate that the application server is required to receive the suggestion for the adaptive location configuration from the enabler server. The method includes sending by the enabler server a response message to the request message received from the application server. The response message indicates an acceptance of the request message by the enabler server. The method includes determining by the enabler server the adaptive location configuration for the target UE by adjusting a location reporting trigger configuration based on a plurality of parameters associated with the target UE and the identity of the target UE. The method includes sending by the enabler server a notification message to the application server. The notification message includes the identity of the target UE and the adaptive location configuration. The adaptive location configuration includes the adjusted location reporting trigger configuration as the suggestion. The method includes receiving by the enabler server an acknowledgement message from the application server in response to the notification message. The acknowledgement message includes whether the application server accepts or rejects the adaptive location configuration as the suggestion.

As described above, provided herein is a method for dynamically adjusting the location reporting trigger in the communication system. The method includes sending by the application server the request message to the enabler server to receive the adaptive location configuration. The request message includes the identity of the target UE for which the application server requires the adaptive location configuration and the indication for a suggestive update to indicate that the application server requires to receive the suggested configurations from the enabler server. The method includes receiving by the application server the response message from the enabler server indicating acceptance of the request message by the enabler server. The method includes receiving by the application server the notification message from the enabler server. The notification message includes the identity of the target UE and the adaptive location configuration, including the adjusted location reporting trigger configuration for the target UE as the suggestion. The method includes determining by the application server whether the adaptive location configuration received from the enabler server is accepted or rejected by the application server. The method includes sending by the application server an acknowledgement message in response to the notification message received from the enabler server. The acknowledgement message includes whether the application server accepts or rejects the adaptive location configuration as the suggestion.

As described above, provided herein is an enabler server for dynamically adjusting a location reporting trigger in the communication system. The enabler server includes a memory including information about the application server and a plurality of UEs in the communication system, a processor, and an adaptive location configuration controller. The adaptive location configuration controller is coupled to the memory and the processor. The adaptive location configuration controller receives the request message from the application server to receive the adaptive location configuration. The request message includes the identity of the target UE for which the application server requires the adaptive location configuration and the indication for a suggestive update to indicate that the application server is required to receive suggestions for the adaptive location configurations from the enabler server. The adaptive location configuration controller sends the response message to the request message received from the application server. The response message indicates the acceptance of the request message by the enabler server. The adaptive location configuration controller determines the adaptive location configuration for the target UE by adjusting the location reporting trigger configuration based on the plurality of parameters associated with the target UE and the identity of the target UE. The adaptive location configuration controller sends the notification message to the application server. The notification message includes the identity of the target UE and the adaptive location configuration. The adaptive location configuration includes the adjusted location reporting trigger configuration as the suggestion. The adaptive location configuration controller receives the acknowledgement message from the application server in response to the notification message. The acknowledgement message includes whether the application server accepts or rejects the adaptive location configuration as the suggestion.

As described above, provided herein is an application server for dynamically adjusting the location reporting trigger in the communication system. The application server includes a memory including information about the enabler server and the plurality of UEs in the communication system, a processor, and an adaptive location configuration controller. The adaptive location configuration controller is coupled to the memory and the processor. The adaptive location configuration controller sends the request message to the enabler server to receive the adaptive location configuration. The request message includes the identity of the target UE for which the application server requires the adaptive location configuration and the indication for a suggestive update to indicate that the application server requires to receive suggestions for the adaptive location configurations from the enabler server. The adaptive location configuration controller receives the response message from the enabler server. The response message indicates an acceptance of the request message by the enabler server. The adaptive location configuration controller receives the notification message from the enabler server. The notification message includes the identity of the target UE and an adaptive location configuration. The adaptive location configuration includes the adjusted location reporting trigger configuration for the target UE as the suggestion. The adaptive location configuration controller determines whether the adaptive location configuration received from the enabler server is accepted or rejected by the application server. The adaptive location configuration controller sends the acknowledgement message in response to the notification message received from the enabler server. The acknowledgement message includes whether the application server accepts or rejects the adaptive location configuration as the suggestion.

Embodiments are described and illustrated in terms of blocks that perform one or more described functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments be physically combined into more complex blocks without departing from the scope of the proposed method.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a service enabler architecture layer (SEAL) location management (LM) server in a wireless communication system, the method comprising:
receiving, from a vertical application layer (VAL) server, a first message for triggering a location reporting, the first message including an identity of a user equipment (UE) and an indicator for requesting a suggestion for an adaptive location reporting configuration;
identifying the adaptive location reporting configuration based on a dynamic adjustment of a location reporting configuration by analysing location information of a client for the UE; and
transmitting, to the VAL server, a second message for suggesting the adaptive location reporting configuration.

2. The method of claim 1,
wherein the dynamic adjustment includes at least one of:
identifying whether to increase or decrease a frequency of location reporting based on a mobility pattern of the UE, or
identifying whether to change location accuracy.

3. The method of claim 1, wherein the second message includes the identity of the UE, and the adaptive location reporting configuration.

4. The method of claim 1, further comprising receiving, from the VAL server, a third message indicating whether the suggestion is accepted or rejected.

5. The method of claim 4, further comprising, in case that the third message indicates that the suggestion is accepted, updating the location reporting configuration to the client for the UE.

6. A method performed by a vertical application layer (VAL) server in a wireless communication system, the method comprising:
transmitting, to a service enabler architecture layer (SEAL) location management (LM) server, a first message for triggering a location reporting, the first message including an identity of a user equipment (UE) and an indicator for requesting a suggestion for an adaptive location reporting configuration; and
receiving, from the SEAL LM server, a second message for suggesting the adaptive location reporting configuration based on a dynamic adjustment of a location reporting configuration by an analysis on location information of a client for the UE.

7. The method of claim 6,
wherein the dynamic adjustment includes at least one of:
identification of whether to increase or decrease a frequency of location reporting based on a mobility pattern of the UE, or
identification of whether to change location accuracy.

8. The method of claim 6, wherein the second message includes the identity of the UE, and the adaptive location reporting configuration.

9. The method of claim 6, further comprising transmitting, to the SEAL LM server, a third message including whether the VAL server accepts or rejects the suggestion.

10. The method of claim 9, wherein, in case that the VAL server accepts the suggestion, the location reporting configuration is updated.

11. A service enabler architecture layer (SEAL) location management (LM) server in a wireless communication system, the SEAL LM server comprising:
a transceiver; and
a controller coupled with the transceiver and configured to:
receive, from a vertical application layer (VAL) server, a first message for triggering a location reporting, the first message including an identity of a user equipment (UE) and an indicator for requesting a suggestion for an adaptive location reporting configuration;
identify the adaptive location reporting configuration based on a dynamic adjustment of a location reporting configuration by analysing location information of a client for the UE; and
transmit, to the VAL server, a second message for suggesting the adaptive location reporting configuration.

12. The SEAL LM server of claim 11, wherein the dynamic adjustment includes at least one of:
identifying whether to increase or decrease a frequency of location reporting based on a mobility pattern of the UE, or
identifying whether to change location accuracy.

13. The SEAL LM server of claim 11, wherein the second message includes the identity of the UE, and the adaptive location reporting configuration.

14. The SEAL LM server of claim 11, wherein the controller is further configured to receive, from the VAL server, a third message indicating whether the suggestion is accepted or rejected.

15. The SEAL LM server of claim 14, wherein the controller is further configured to, in case that the third message indicates that the suggestion is accepted, update the location reporting configuration to the client for the UE.

16. A vertical application layer (VAL) server in a wireless communication system, the VAL server comprising:
a transceiver; and
a controller coupled with the transceiver and configured to:
transmit, to a service enabler architecture layer (SEAL) location management (LM) server, a first message for triggering a location reporting, the first message including an identity of a user equipment (UE) and an indicator for requesting a suggestion for an adaptive location reporting configuration; and
receive, from the SEAL LM server, a second message for suggesting the adaptive location reporting configuration based on a dynamic adjustment of a location reporting configuration by an analysis on location information of a client for the UE.

17. The VAL server of claim 16, wherein the dynamic adjustment includes at least one of:
identification of whether to increase or decrease a frequency of location reporting based on a mobility pattern of the UE, or
identification of whether to change location accuracy.

18. The VAL server of claim 16, wherein the second message includes the identity of the UE, and the adaptive location reporting configuration.

19. The VAL server of claim 16, wherein the controller is further configured to transmit, to the SEAL LM server, a third message including whether the VAL server accepts or rejects the suggestion.

20. The VAL server of claim 19, wherein, in case that the VAL server accepts the suggestion, the location reporting configuration is updated.
